(19) United States
(12) Patent Application Publication
(10) Pub. No.: US 2020/0120913 A1
(43) Pub. Date: Apr. 23, 2020

(54) Two Fly Setup

(71) Applicant: Robert P. Rost, Ligonier, PA (US)

(72) Inventor: Robert P. Rost, Ligonier, PA (US)

(21) Appl. No.: 16/477,964

(22) PCT Filed: Jan. 22, 2018
(86) PCT No.: PCT/US2018/014620

§ 371 Date: Jul. 15, 2019

Related U.S. Application Data
(60) Provisional application No. 62/449,244, filed on Jan. 23, 2017.

(51) Int. Cl. A01K 91/12; A01K 85/08

(52) U.S. Cl. CPC A01K 91/12; A01K 85/08

(57) ABSTRACT

Provided herein is a tippet line for fly fishing that is adapted to receive a bend of a hook, thereby eliminating the need for a knot. The tippet line includes a first end, a second end for attaching to a hook of a dropper fly, and an enlarged section adapted to receive a hook, wherein the enlarged section extends from the tippet line between the first end and the second end.

### CROSS REFERENCE TO RELATED APPLICATIONS

This application claims priority to U.S. Patent Application No. 62/449,244, filed Jan. 23, 2017, the disclosure of which is hereby incorporated in its entirety by reference.

### BACKGROUND OF THE INVENTION

### Field of the Invention

This invention generally relates to a tippet line used for sport fishing and more particularly to a tippet line for fly fishing having an enlarged section adapted to receive a hook.

### Description of Related Art

In the sport of fly fishing, an angler uses a long, flexible fly rod made of bamboo, fiberglass, or graphite, and a fly reel to hold a floating or non-floating fly line that is attached to a tapered or non-tapered leader upon which an artificial fly or insect replica is attached. The free end of the leader is often referred to as the tippet. The tippet end of the leader is often replaced or added to by non-tapered tippet material which is unwound from a spool, severed at a desired length and tied to the end of the leader. Each of the lines are traditionally tied together with one of several knots. For example, an angler ordinarily secures the leader line to the tippet via a blood knot or a surgeon's knot.

The leader and the tippet line are typically monofilament and clear, providing a nearly invisible transition from the fly line to the fly, thus presenting the fly or the lure in a more attractive manner to the fish.

Although fly fishing is sometimes performed using a single fly, it is not uncommon for an angler to secure a second, or may be even a third fly to the line. As discussed herein, the fly attached directly to the end of the leader is referred to as the “point fly” and if additional flies are attached, those additional flies are referred to as “dropper flies”.

Problems associated with attaching dropper flies using the traditional method include the fact that many traditionally reliable knots are difficult to tie while fishing and can be especially difficult if the angler has poor eyesight or finger dexterity. Moreover, because the tippet frequently needs replaced as a result of breakage or a change in fishing conditions, the angler must tie several knots over the course of a fishing outing.

### SUMMARY OF THE INVENTION

The present invention overcomes the problems associated with the traditional devices by utilizing a hook to directly secure the tippet line to the leader, thereby eliminating the need for an angler to tie a knot.

The present invention is a tippet line for fly fishing. The tippet line is normally stored on a spool until a desired amount of tippet material is unwound and severed from the spool, just prior to use. When severed, the tippet line includes a first end, a second end for attaching a dropper fly, and an enlarged section adapted to receive a hook. While stored on the spool, the enlarged sections are spaced apart in equidistant intervals. The equidistant interval may be any predetermined length such as 4 feet or 6 feet.

The enlarged section extends from the tippet line between the first end and the second end. The enlarged section may either define a pre-formed hole or slot therein, a perforated slot, or be made of pierceable material to receive the hook. In one preferred embodiment, the enlarged section comprises fibers to increase the tensile strength of the enlarged section relative to the other portions of the tippet line. The enlarged section may optionally include a flexible ring positioned around the edge of the slot for receiving the hook to prevent the enlarged section from tearing.

Further details and advantages will be understood from the following detailed description read in conjunction with the accompanying drawings.

### BRIEF DESCRIPTION OF THE DRAWINGS

The present invention is described in further detail with reference to the accompanying figures, in which:

FIG. 1A shows attachment of a dropper fly to a hook of a point fly;

FIG. 1B shows attachment of a dropper fly to a tag end of a leader ahead of a point fly;

FIG. 1C shows attachment of a dropper fly to a tippet tied to an eye of a point fly;

FIG. 1D shows the traditional method of attaching a dropper fly to a point fly, a knot;

FIG. 2 is a perspective view of an embodiment of the tippet line wound on a spool and made in accordance with the present invention;

FIG. 3 is a perspective view of an embodiment of the tippet line of FIG. 2 unwound from the spool made in accordance with an embodiment of the present invention;

FIG. 4A is a top plan view of the tippet line of FIG. 2 unwound and severed from the spool made in accordance with an embodiment of the present invention;

FIG. 4B is a top plan view of the tippet line of FIG. 2 unwound and severed from the spool made in accordance with another embodiment of the present invention;

FIG. 4C is an isolated perspective view of section C of FIG. 3;

FIG. 5 is a top plan view of an embodiment of an enlarged section of the tippet line of the present invention;

FIG. 6 is a top plan view of an embodiment of an enlarged section of the tippet line of the present invention;

FIG. 7A is a top plan view of the tippet line, prior to attachment of a point fly, in accordance with an embodiment of the present invention;

FIG. 7B is a top plan view of FIG. 7A, after attachment of the point fly;

FIG. 8A is a top plan view of the tippet line, prior to attachment of a point fly, in accordance with an embodiment of the present invention;

FIG. 8B is a top plan view of FIG. 7A, after attachment of the point fly; and

FIG. 9 is a top plan view of the tippet line, prior to attachment of a point fly, in accordance with an embodiment of the present invention.

### DESCRIPTION OF THE INVENTION

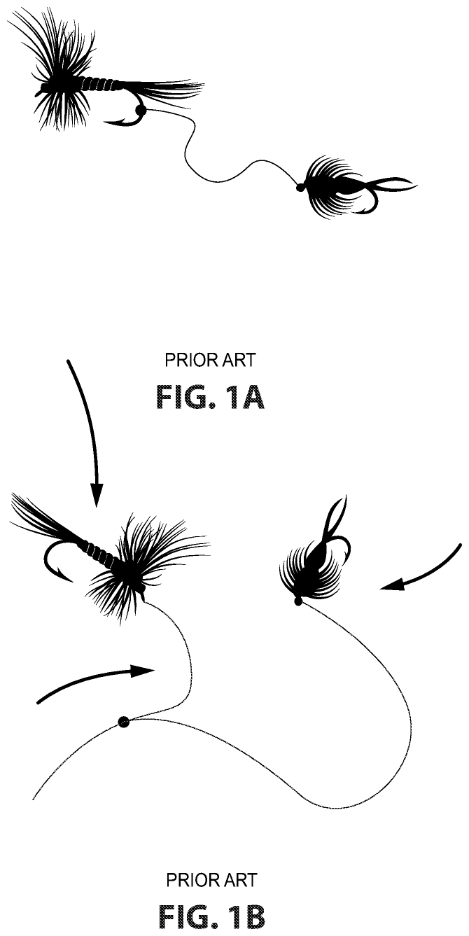

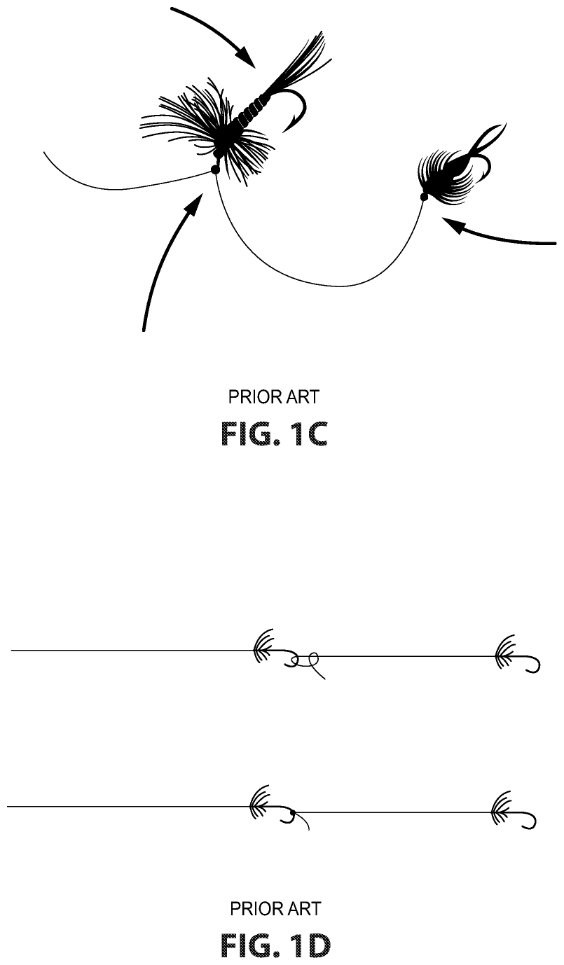

There are three main attachment setups for attaching a dropper fly to a point fly. As shown in FIG. 1A, the dropper fly can be attached to the hook of the point fly. As shown in FIG. 1B, the dropper fly can be attached to a tag end of the leader ahead of the point fly. Alternatively, as shown in FIG. 1C, the dropper fly can be attached to a tippet section tied to an eye of the point fly. As is illustrated in FIGS. 1A-1C, regardless of the attachment setup, the dropper line is traditionally tied to the point fly using a knot, as shown in FIG. 1D.

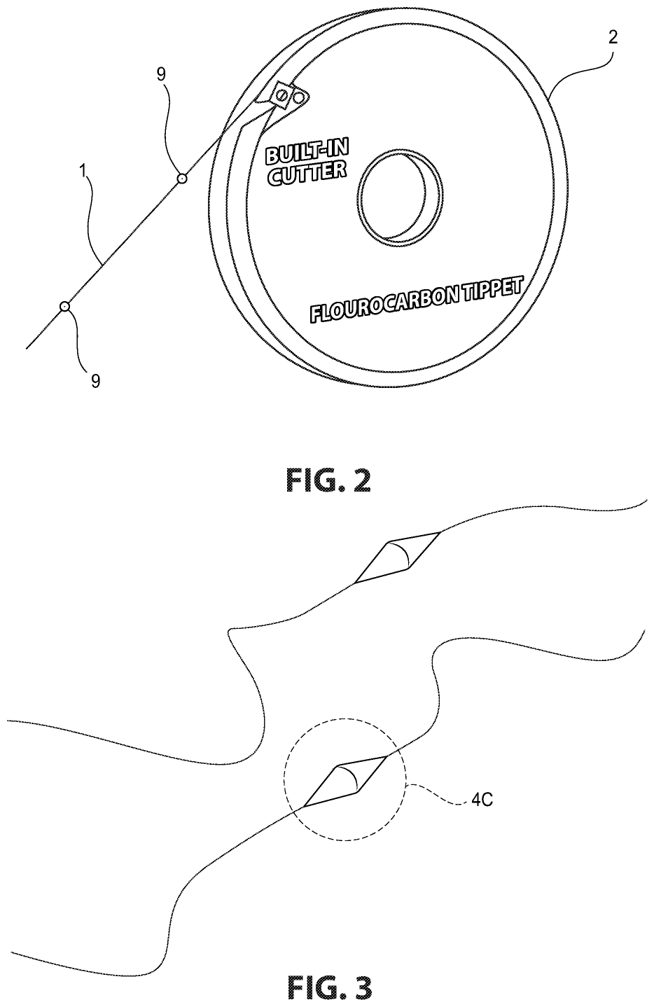

The tippet line 1 provided by the present invention is adapted to receive a bend of a hook to directly attach a dropper fly 3, thereby eliminating the need for the angler to tie a knot. As shown in FIG. 2, like traditional tippet line, the tippet line 1 of the present invention may be wrapped on a spool 2, until just prior to use when a desired amount of tippet line 1 is unwound and severed from the spool 2. FIG. 3 shows the tippet line 1 after it has been unwound from the spool 2.

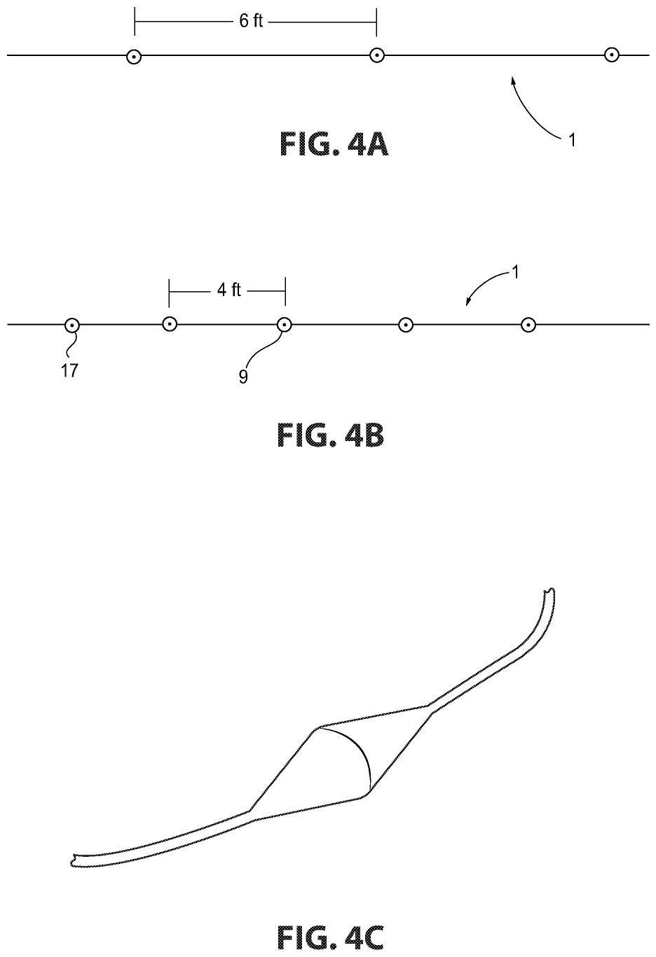

FIGS. 4A and 4B illustrate a section of the tippet line 1 after it has been dispensed and severed from the spool 2. The tippet line 1 includes a first end 5, a second end 7 for attaching a dropper fly 3, and an enlarged section 9, as shown in FIG. 4C. The enlarged section 9 is ultimately retained by the bend of a hook. As discussed herein, the hook may refer to a hook attached to the leader 11, a hook attached to the tag end of the tippet line 1, or a hook attached to a second dropper fly if more than one dropper fly is utilized. The enlarged section 9 extends radially from a longitudinal axis L of the tippet line 1 at a location between the first end 5 and the second end 7.

The tippet line 1 may be manufactured from any material in which traditional tippet lines are manufactured, including monofilament, fluorocarbon, or nylon.

While wound on the spool 2, the tippet line 1 includes a plurality of enlarged sections 9 that extend radially from the longitudinal axis L. The plurality of enlarged sections 9 are spaced apart in equidistant intervals. The equidistant interval may be any predetermined length including, for example, 4 feet as shown in FIG. 4B, or 6 feet, as shown in FIG. 4A.

The enlarged section 9 may be formed as any shape including, but not limited to globular, cylindrical, conical, double conical (FIG. 4C) egg shaped, or flat 17. The enlarged section 9 defines a hole or a slot 19 to receive a bend of a hook 11. The slot may be completely pre-formed or perforated. Alternatively, the enlarged section 9 could be manufactured from a solid, puncturable material thereby permitting the user to puncture the slot 19 with a point 21 of the hook 11 and to slide the hook therethrough, securing the enlarged section a within a bend of the hook 11.

The tensile strength of the enlarged section 9 is at least equal to, or preferably greater than, the tensile strength of the other portion of the tippet line 1 to prevent failure of the tippet line 1 at the enlarged section 9 as a result of the hook 11.

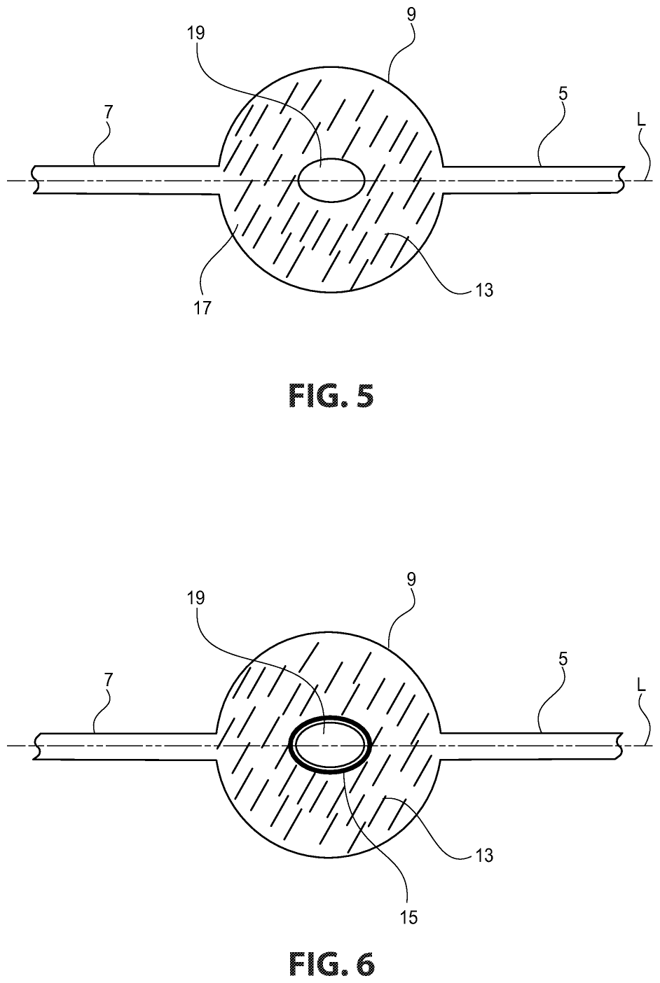

As shown in FIG. 5, the enlarged section 9 includes fibers 13 to increase the tensile strength of the enlarged section 9 relative to the other portions of the tippet line 1.

As shown in FIG. 6, the enlarged section 9 may optionally include a flexible ring 15 that may be slightly elongated in shape.

The tippet line 1 disclosed herein is advantageous over the traditional device as it directly receives the hook 11 eliminating the need for the angler to tie the dropper fly 3 to the hook 11 or the leader.

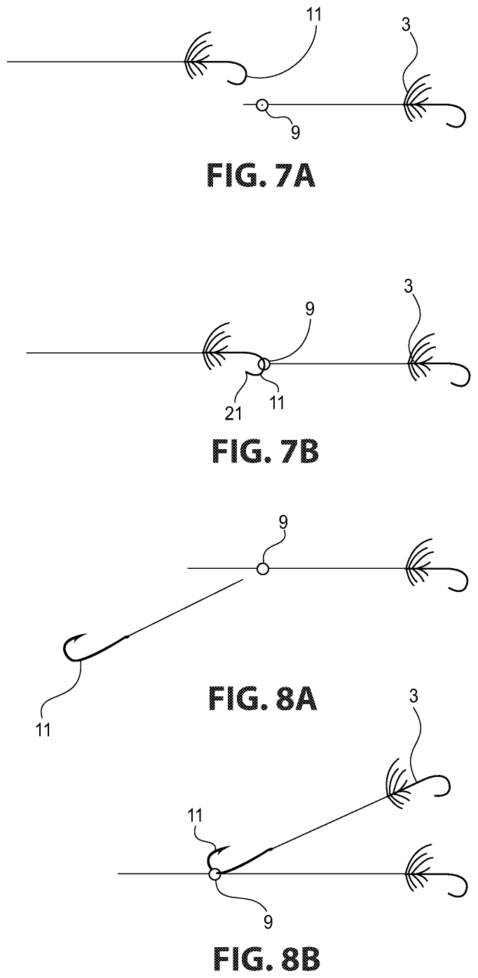

Referring to FIGS. 7A and 7B, to attach the tippet line 1 to the leader, particularly to attach the dropper fly 3 to the hook of the point fly, the angler simply slides the point 21 of the hook through the slot 19, until the bend of the hook 11 retains the enlarged section 9, thereby securing the lines together without a knot. Once secured, the angler then pulls on the leader line to unravel the tippet line 1 to a desired length before trimming the tippet 1 and attaching the dropper fly 3.

Referring to FIGS. 8A and 8B, to attach the tippet line 1 to the leader, particularly to attach the tag end of the dropper fly to the leader, with a hook 11 attached to the tag end, the angler threads the opposing end of the tippet line through the slot 19 until the bend of the hook 11 retains the enlarged section 9. The angler then attaches the dropper fly 3 in an ordinary manner.

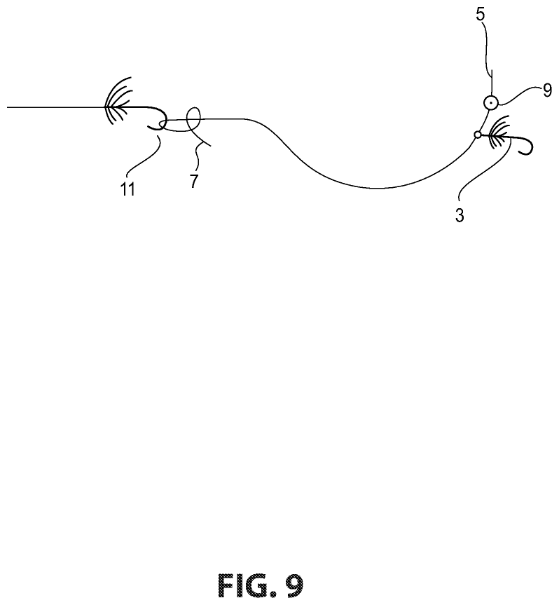

Referring to FIG. 9, an angler can also attach a dropper fly 3 by threading a second end 7 of the tippet line 1 through an eye of the dropper fly 3 until the dropper fly 3 contacts and settles at the enlarged section 9. The second end 7 of the tippet line 1 is then tied to a hook 11 of the point fly, thereby, attaching the dropper fly 3 between the point fly and the enlarged section 9 and eliminating the need to tie the dropper fly 3 to the tippet line 1.

While embodiments of a tippet line are shown in the accompanying figures and described hereinabove in detail, other embodiments will be apparent to, and readily made by, those skilled in the art without departing from the scope and spirit of the invention. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

We claim:

1. A tippet line for fly fishing comprising:
a first end;
a second end for attaching a dropper fly; and
an enlarged section adapted to receive a hook, wherein the enlarged section extends from the tippet line between the first end and the second end.

2. The tippet line of claim 1, wherein the enlarged section comprises fibers.

3. The tippet line of claim 1, wherein the enlarged section is flat in shape.

4. The tippet line of claim 1, wherein the enlarged section defines a slot therein.

5. The tippet line of claim 4, wherein the enlarged section comprises a flexible ring at least partially surrounding the slot.

6. The tippet line of claim 1, wherein the enlarged section is pierceable.

7. The tippet line of claim 1, wherein when the tippet line is wound on a spool, the tippet line comprises a plurality of enlarged sections.

8. The tippet line of claim 7, wherein the plurality of enlarged sections are spaced apart in equidistant intervals.

9. The tippet line of claim 8, wherein the equidistant interval is four feet.

10. The tippet line of claim 8, wherein the equidistant interval is six feet.
